(19) United States
(12) Patent Application Publication
(10) Pub. No.: US 2019/0290058 A1
(43) Pub. Date: Sep. 26, 2019

(54) FOOD COOKER WITH DETACHABLE STIRRER

(71) Applicant: DWEMER DESIGN LTD., Taipei City (TW)

(72) Inventor: WU CHOU KUO, Tainan City (TW)

(21) Appl. No.: 15/934,454

(22) Filed: Mar. 23, 2018

(51) Int. Cl. A47J 36/16; A47J 43/044; A47J 27/00

(52) U.S. Cl. CPC A47J 36/165; A47J 2043/0449; A47J 27/002; A47J 43/044

(57) ABSTRACT

A food cooker includes a heater; an outer container, which is removably placed on the heater and for accommodating a liquid, wherein the heater heats the outer container; an inner container, which is removably accommodated within the outer container and has multiple through holes allowing the liquid to flow between the outer container and the inner container, wherein the inner container is for accommodating a food; a cover disposed on the outer container; a power source, which is disposed on the cover and has a driving shaft; and a stirrer, which is detachably and rotatably placed in the inner container, is detachably coupled to the driving shaft, and is rotated by the driving shaft to stir the food and the liquid.

### BACKGROUND OF THE INVENTION

### Field of the Invention

This disclosure relates to a food cooker, and more particularly to a food cooker with a detachable stirrer.

### Description of the Related Art

Food toppings for desert and beverages including beans, starch foods, and fruits need to be stirred during the cooking process. Food toppings such as Taiwanese tapioca pearls (also called Boba or Bubble), tapioca balls, tapioca cubes, taro balls, taro cubes, or beans are frequently added to a drink to add flavors. However, the employees of the beverage shops have a very high work load because of the long cooking process time (the cooking time is about 85 minutes) and high labor consumption for manually cooking the toppings. The quality of cooked tapioca pearls is hard to control because it's very sensitive to the cooking process, such as the stirring speed, stirrer profile, and stirring timing control. In addition, the cooking process consumes a lot of energy because the cooking process isn't optimized. Thus, the stable quality cannot be provided to the customers efficiently.

In addition, the ratio of the pearls to water typically ranges from (1:6) to (1:8), and the usage of the water is very high. Moreover, some pearls tend to stick to the bottom of the pot during the cooking process, which affects the taste of the whole batch of pearls. Thus, the conventional cooking apparatus needs to be improved.

### BRIEF SUMMARY OF THE INVENTION

An objective of this disclosure is to provide a food cooker with a detachable stirrer, which can be rapidly detached and installed.

Another objective of this disclosure is to provide a food cooker with an automatic food supply device capable of automatically feeding the food.

To achieve the above-identified object, this disclosure provides a food cooker including a heater; an outer container, which is removably disposed on the heater and for accommodating a liquid, wherein the heater heats the outer container; an inner container, which is removably accommodated within the outer container and has multiple through holes to allow the liquid to flow between the outer container and the inner container, wherein the inner container is for accommodating a food; a cover disposed on the outer container; a power source, which is disposed on the cover and has a driving shaft; and a stirrer, which is detachably and rotatably disposed in the inner container, is detachably coupled to the driving shaft, and is rotated by the driving shaft to stir the food and the liquid.

With the above-mentioned aspect of this disclosure, the provided food cooker has the detachable stirrer that can be rapidly detached and installed, and the automatic food supply device that can automatically feed the food. In addition, a lot of water can be saved, the cooking time can be shortened, the operator's work load can be decreased, and the food with the uniform quality can be obtained.

Further scope of the applicability of this disclosure will become apparent from the detailed description given hereinafter. However, it should be understood that the detailed description and specific examples, while indicating preferred embodiments of this disclosure, are given by way of illustration only, since various changes and modifications within the spirit and scope of this disclosure will become apparent to those skilled in the art from this detailed description.

### BRIEF DESCRIPTION OF THE SEVERAL VIEWS OF THE DRAWINGS

FIGS. 1 and 2 are a pictorial view and a side view showing a food cooker according to a preferred embodiment of this disclosure, respectively.

FIG. 3 is a schematic view showing a stirrer, an outer container and an inner container.

FIG. 4 is a partial side view showing the food cooker in a non-dispensing state.

FIGS. 5 and 6 are a partial pictorial view and a partial side view showing the food cooker in a dispensing state, respectively.

FIG. 7 is a partial pictorial view showing a quantity control member, an outlet valve and a quantity control barrel in the dispensing state.

FIG. 8 is a circuit block diagram showing the food cooker.

FIG. 9 is a pictorial view showing another stirrer.

FIG. 10 is a side view showing the stirrer of FIG. 9.

### DETAILED DESCRIPTION OF THE INVENTION

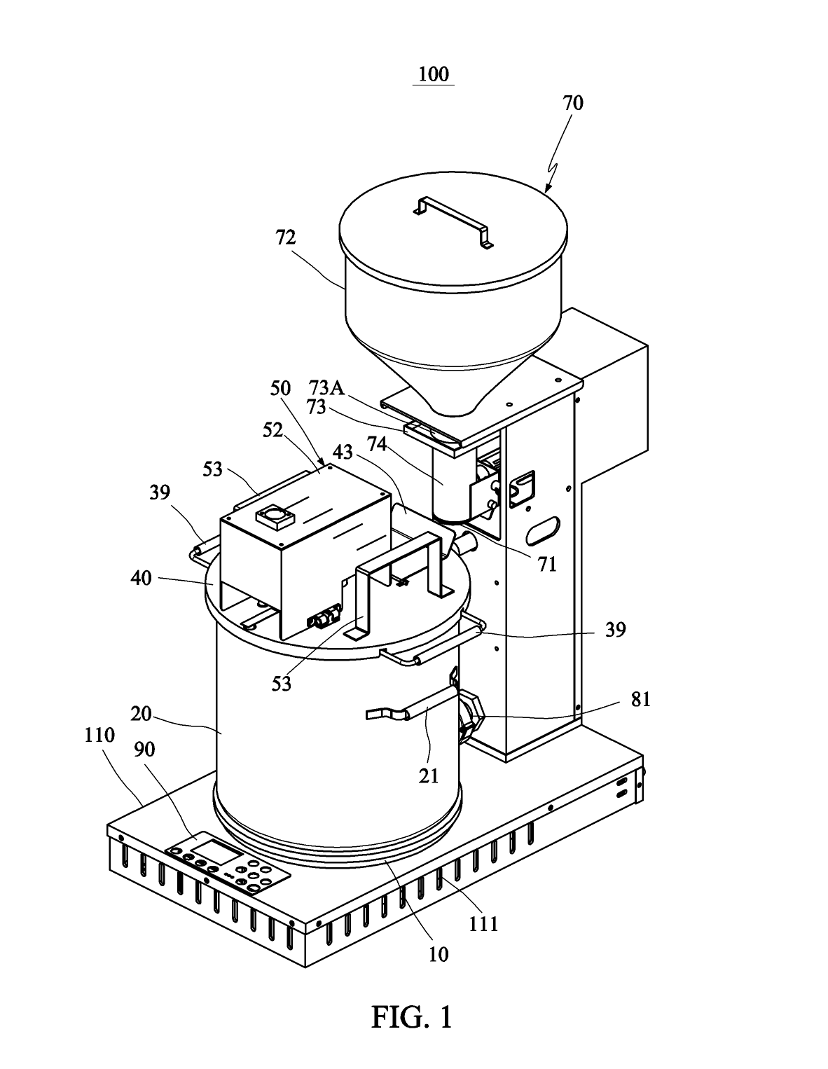

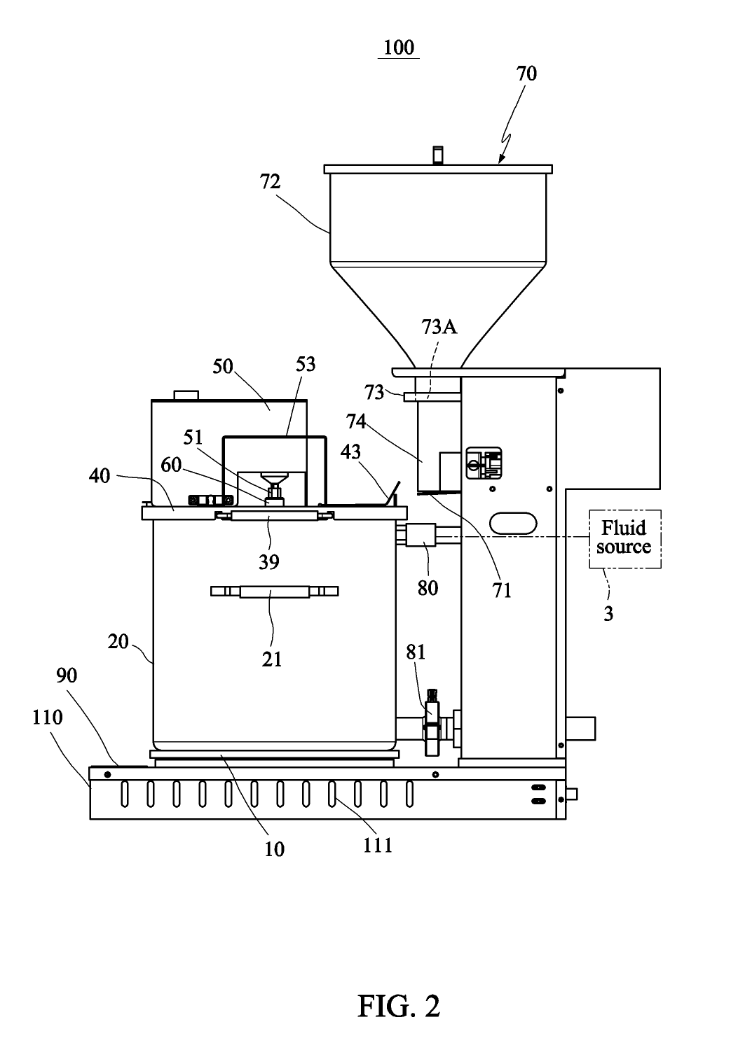

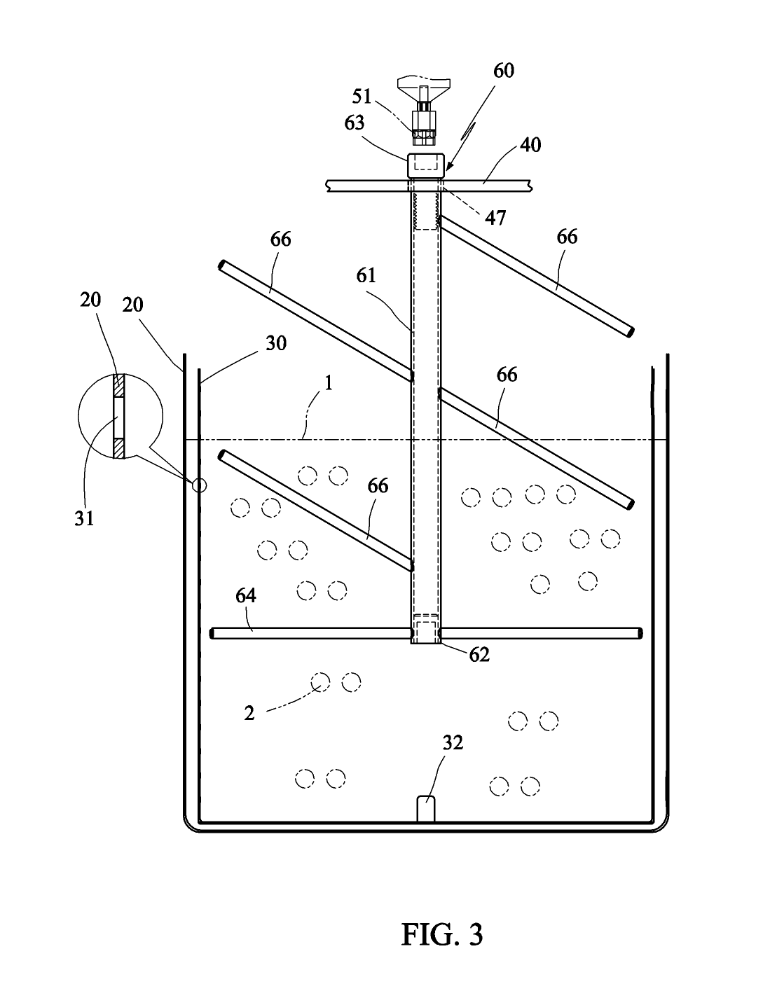

FIGS. 1 and 2 are respectively a pictorial view and a side view showing a food cooker according to a preferred embodiment of this disclosure, respectively. FIG. 3 is a schematic view showing a stirrer, an outer container and an inner container, wherein the stirrer is in a non-working state to help the reader understand the structure. Referring to FIGS. 1 to 3, this embodiment provides a food cooker 100, which includes a heater 10, an outer container 20, an inner container 30, a cover 40, a power source 50 and a stirrer 60.

The outer container 20 is removably disposed (or placed) on the heater 10 and for accommodating a liquid 1. The liquid 1 includes, for example but without limitation to, water, edible oil or the like. The heater 10 heats the outer container 20 to indirectly heat the liquid 1. The heater 10 disposed in a body 110 includes, for example but without limitation to, an induction heating cooker, a gas stove or the like. The body 110 is formed with vents 111 for heat dissipating. A handle 53 is formed on the cover 40 so that the operator can grip the handle 53 and lift up the cover 40. The outer container 20 is provided with two handles 21, through which the operator can move the outer container 20. The inner container 30 is also provided with two handles 39 through which the operator can move the inner container 30 up.

The inner container 30 is removably accommodated (or placed) within the outer container 20, and has multiple through holes 31 to allow the liquid 1 to flow between the outer container 20 and the inner container 30, and the inner container 30 is for accommodating a food or foods 2. In this example embodiment, the food 2 includes Taiwanese pearls, balls, tapioca balls or tapioca pearls. However, this disclosure is not limited thereto. In other embodiments, the food 2 may also be rice, wheat, peanuts, beans and other foods.

The cover 40 is disposed or attached on the outer container 20, and has the functions of providing heat preservation and reducing liquid evaporation. The power source 50 is disposed or attached on the cover 40 and has a driving shaft 51. For example, the power source 50 includes a motor functioning to provide power for rotation. Of course, the motor can also cooperate with a reduction gear set to provide the larger power for rotation.

The stirrer 60 includes a central shaft 61, a horizontal lever 64 and multiple blades 66. The central shaft 61 has a bottom end 62 and a top end 63, the bottom end 62 is detachably and rotatably disposed in the inner container 30, and the top end 63 is detachably coupled to the driving shaft 51. The horizontal lever 64 is connected to the bottom end 62 of the central shaft 61 for stirring the food 2 near the bottom of the inner container 30 to prevent the food 2 from sticking to the bottom of the inner container 30. In this embodiment, the stirrer 60 passes through an opening 47 of the cover 40. In another embodiment, the driving shaft passes through the cover.

Therefore, the stirrer 60 is detachably and rotatably disposed (or placed) in the inner container 30, is detachably coupled to the driving shaft 51, and is rotated by the driving shaft 51 to stir the food 2 and the liquid 1. The stirrer 60 is, for example, a stirring blade, and can be used to stir the food 2 and more particularly to stir the food 2 downwards to bring the food exposed from the liquid surface downwards to achieve the circulation. After cooking is completed, the operator can conveniently remove the stirrer 60 for thorough cleaning, and even can replace another stirrer with the removed stirrer 60 according to different cooking requirements. In this non-limiting example, the inner container 30 has a pillar or post 32, and the stirrer 60 is rotatably connected to or fitted with the pillar 32. In this way, the stirrer 60 can stably stir the food and liquid with both ends well fixed to prevent the stirring blades, which almost extend and cover the entire inner container 30 (the radial coverage is greater than 70%, 80% or 90%) from colliding with the circumferential wall of the inner container 30. In this embodiment, when the cover 40 is closed on the outer container 20, the stirrer 60 can be coupled to the driving shaft 51; and when the cover 40 leaves the outer container 20, the stirrer 60 can be separated from the driving shaft 51 without additionally operations.

In addition, the above-mentioned food cooker 100 may further include an operation interface 90, a fluid supply valve 80 and a fluid dispensing valve 81. The fluid supply valve 80 communicates with the outer container 20 and a fluid source 3, and is used to control supplying of the liquid 1 from the fluid source 3 to the outer container 20 or not. The fluid dispensing valve 81 communicates with the outer container 20, and is used to control discharging of the liquid 1 from the outer container 20 or not. The fluid supply valve 80 and the fluid dispensing valve 81 may be connected to the outer container 20 through quick connection/disconnection connectors to facilitate the freehand quick connection/disconnection operations of the operator.

The above-mentioned food cooker can achieve semi-automatic cooking. In order to achieve the function of automatic cooking, the food cooker 100 may further include a food supply device 70 for accommodating the food 2 and supplying the food 2 into the inner container 30.

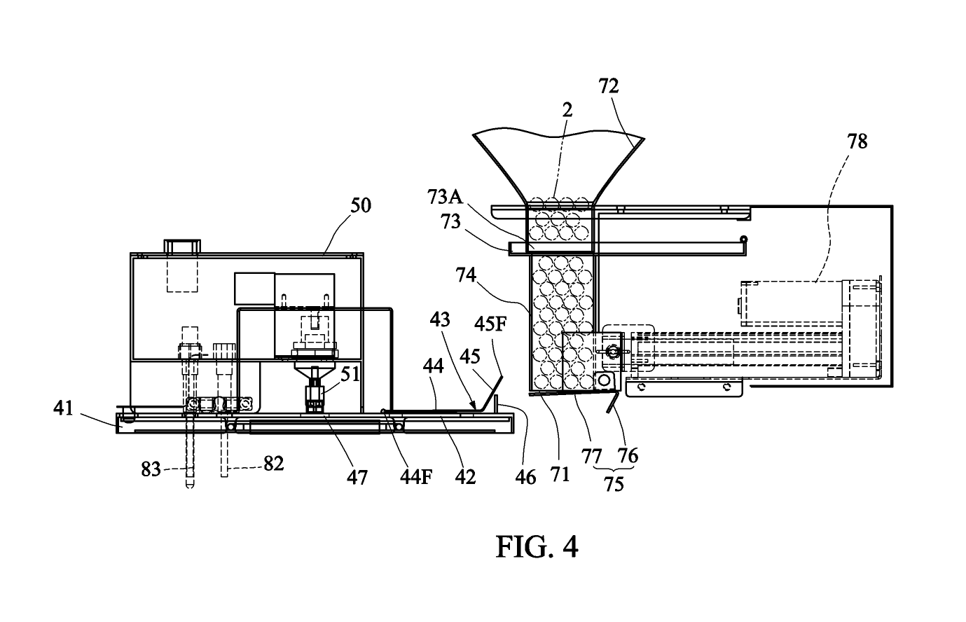

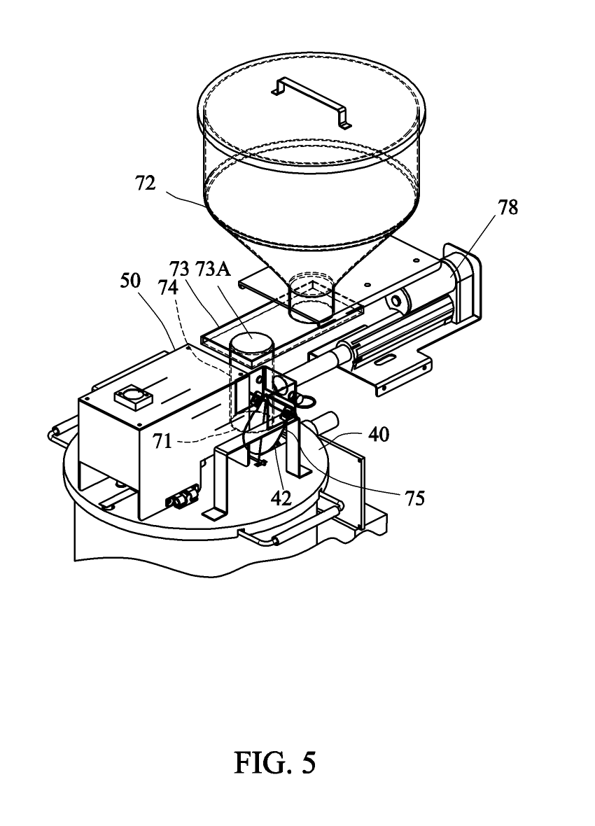

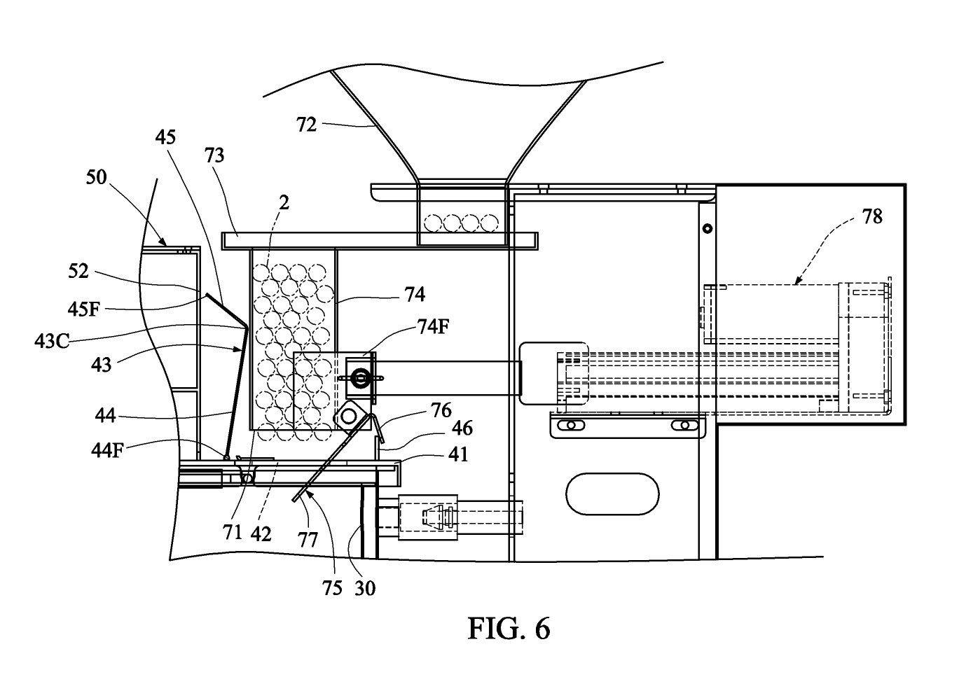

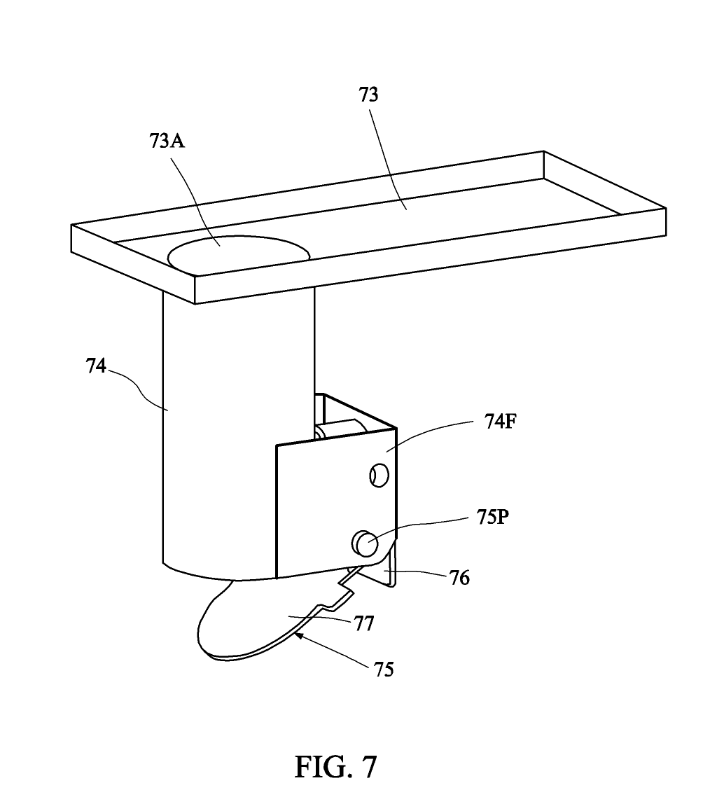

FIG. 4 is a partial side view showing the food cooker in a non-dispensing state. FIGS. 5 and 6 are a partial pictorial view and a partial side view showing the food cooker in a dispensing state, respectively. FIG. 7 is a partial pictorial view showing a quantity control member, an outlet valve and a quantity control barrel in the dispensing state. As shown in FIG. 4, a dispensing port (or dispensing opening) 71 of the food supply device 70 is not located directly above the cover 40 in the non-dispensing state. As shown in FIGS. 5 to 7, the dispensing port 71 is moved to the location directly above the cover 40 in the dispensing state.

The cover 40 includes a base 41 and a rotatable feeding valve 43. The base 41 is formed with an inlet window 42, and the dispensing port 71 is aligned with the inlet window 42 in the dispensing state. The feeding valve 43 is rotatably connected to the base 41. When the food supply device 70 is moved from the non-dispensing state to the dispensing state, the food supply device 70 pushes the feeding valve 43 to rotate and to expose the inlet window 42. In order to prevent the feeding valve 43 from falling down toward the left side of FIG. 6 when the food supply device 70 pushes the feeding valve 43 to rotate, a casing 52 of the power source 50 may be used to stop the feeding valve 43.

When the food supply device 70 is moved from the dispensing state (see FIG. 6) to the non-dispensing state (see FIG. 4), the feeding valve 43 falls by the gravity to close the inlet window 42. In order to achieve the above-mentioned functions, the feeding valve 43 has a first plate 44 and a second plate 45, which are connected together and are not co-planar (disposed on different planes). A pivotal or an axial connection side 44F of the first plate 44 is rotatably connected to the base 41, and a free side 45F of the second plate 45 is pushed by the food supply device 70 to open the feeding valve 43.

Referring to FIGS. 4 to 7, the food supply device 70 includes a storage tank 72, a quantity control member (or quantification member) 73, a quantity control barrel 74 and an outlet valve 75. The storage tank 72 accommodates the food 2. The quantity control member 73 has a quantity control opening 73A communicating with the storage tank 72. The quantity control barrel 74 has one end (top end) communicating with the quantity control opening 73A, and the other end formed with the dispensing port 71, and the quantity control barrel 74 is movable relatively to the storage tank 72. The outlet valve 75 is disposed at the dispensing port 71 to close or open the dispensing port 71. When the outlet valve 75 is closed, as shown in FIG. 4, the quantity control opening 73A communicates with the quantity control barrel 74 and the storage tank 72, and the food 2 falls from the storage tank 72 and enters the quantity control barrel 74 through the quantity control opening 73A, so that the quantity control barrel 74 stores a predetermined amount of food 2 to achieve a quantifying function.

When the outlet valve 75 is opened, as shown in FIGS. 5 to 7, the quantity control barrel 74 does not communicate with the storage tank 72, and the food 2 in the entire quantity control barrel 74 enters the inner container 30 through the inlet window 42 (see FIG. 3). Then, the quantity control barrel 74 returns to the state of FIG. 4 again to accommodate the predetermined amount of food 2.

As shown in FIGS. 4 to 7, the outlet valve 75 is rotatably connected to the quantity control barrel 74 (including a frame 74F) through a pin 75P, and the cover 40 further comprises a stopper structure 46 disposed on the base 41. When the quantity control barrel 74 is moved to the location directly above the inlet window 42, a hook portion 76 of the outlet valve 75 is stopped by the stopper structure 46 to rotate the outlet valve 75, so that a food stopper 77 of the outlet valve 75 is opened relatively to the dispensing port 71 to let the food 2 fall down. It is worth noting that the amount of cooking food at one time may be N times of the amount of food that can be accommodated within the quantity control barrel 74, where N is an integer greater than 1.

The food supply device 70 may further include a driving mechanism 78 for driving the quantity control barrel 74 to move. However, this disclosure is not limited thereto. When the driving mechanism 78 is not present, the operator can manually move the quantity control barrel 74. The driving mechanism 78 may a linear actuator including, for example but without limitation to, a motor, gears, a screw and a nut.

It is worth noting that the first plate 44 and the second plate 45 are connected together to form a connection portion 43C. The connection portion 43C rests against the quantity control barrel 74 in the dispensing state (see FIG. 6), and when the quantity control barrel 74 moves to the right, the feeding valve 43 falls by the gravity.

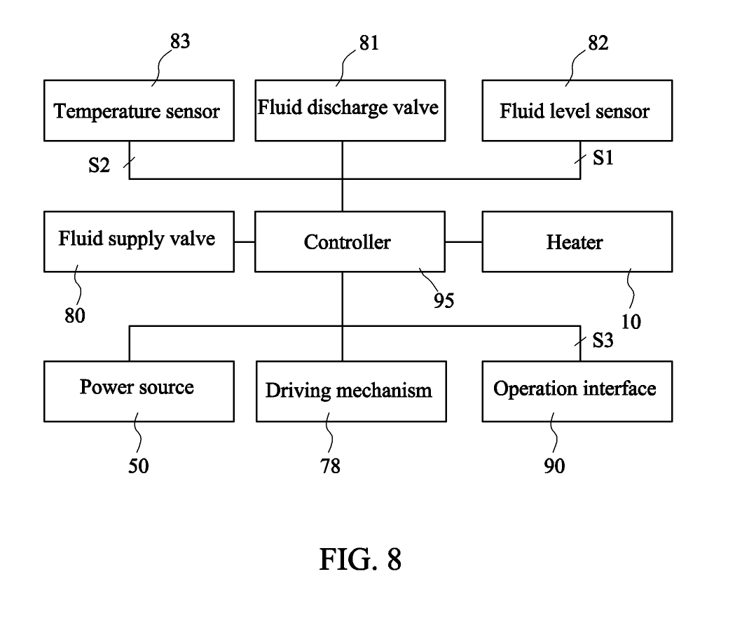

FIG. 8 is a circuit block diagram showing the food cooker. Referring to FIGS. 4 and 8, the food cooker 100 may further include a fluid level sensor 82 and a temperature sensor 83. The fluid level sensor 82 is disposed on the cover 40, and detects a level of the liquid 1 in the outer container 20 or the inner container 30 to generate a liquid level signal 51. The temperature sensor 83 is disposed on the cover 40, and detects a temperature of the liquid 1 in the outer container 20 or the inner container 30 to generate a temperature signal S2.

As shown in FIGS. 8 and 1, the food cooker 100 further include a controller 95, which may be disposed in the body 110. The operation interface 90 is operated by the operator to generate an operation signal S3. The controller 95 is electrically connected to the operation interface 90, the fluid supply valve 80, the fluid discharge valve 81, the fluid level sensor 82, the temperature sensor 83, the heater 10 and the power source 50, and controls operations of the fluid supply valve 80, the fluid discharge valve 81, the heater 10 and the power source 50 according to the liquid level signal 51, the temperature signal S2 and the operation signal S3.

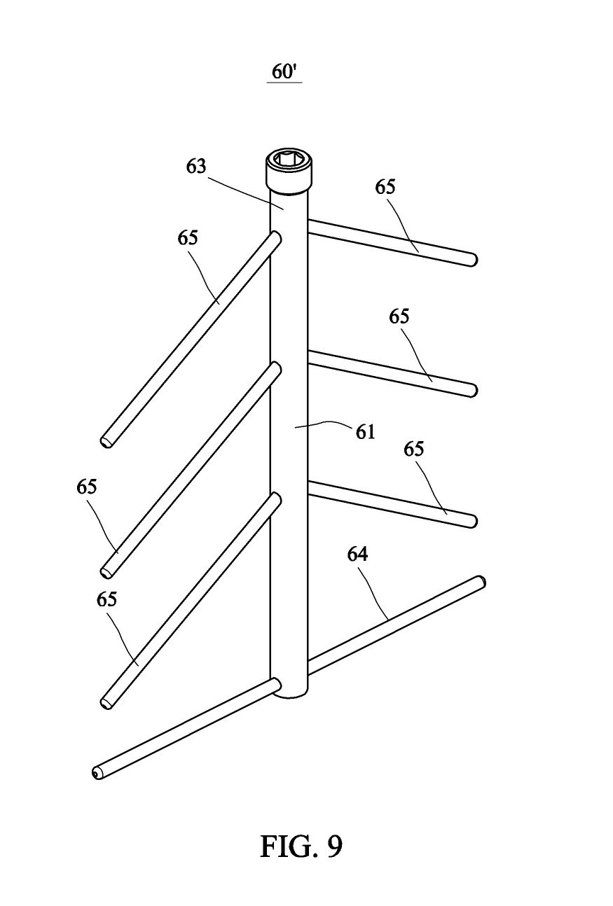

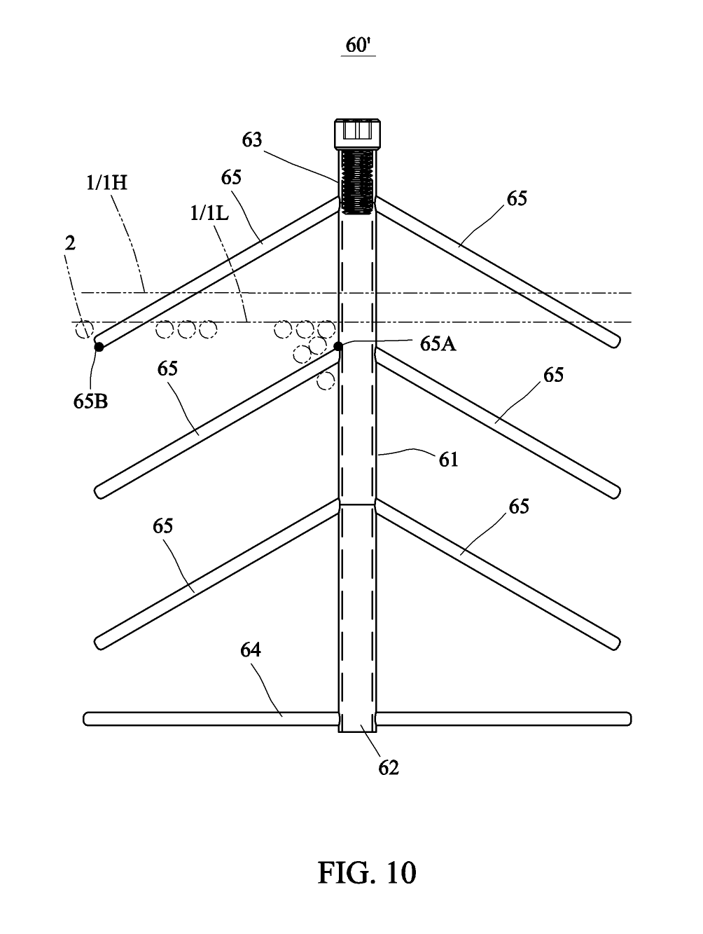

FIG. 9 is a pictorial view showing another stirrer 60′. FIG. 10 is a side view showing the stirrer of FIG. 9. Referring to FIGS. 9 and 10, the stirrer 60′ includes: a central shaft 61 having a bottom end 62 and a top end 63, wherein the bottom end 62 is detachably and rotatably disposed in the inner container, and the top end 63 is detachably coupled to the driving shaft; a horizontal lever 64, which is connected to the bottom end 62 of the central shaft 61 and stirs the food near the bottom of the inner container; and multiple downwardly inclined levers 65, which are connected to the central shaft 61, extend slantingly from the central shaft 61, and stir the food. One or two of the downwardly inclined levers 65 are partially disposed in the liquid 1, and are partially disposed above the liquid 1. That is, the stirring blade is not completely immersed in the liquid 1. In another embodiment, the inclined levers 65 may also be replaced with multiple upwardly inclined levers.

In other words, in two downwardly inclined levers 65 abutting upon each other in a vertical direction, a free end 65B of an upper one of the downwardly inclined levers 65 is lower than or flush with a fixing end 65A of the other lower one of the downwardly inclined levers 65. Because the food 2 being cooked may absorb the liquid and expand and the level of the liquid 1 rises from the liquid surface 1L to the liquid surface 1H. Thus, the design of the levels or heights of the free end 65B and the fixing end 65A of the downwardly inclined levers 65 of the stirrer 60′, can ensure that the outer food 2 and the inner food 2 can be stirred by the stirrer 60′ when the liquid level changes.

The operation processes of the food cooker will be described with reference to FIGS. 1 to 10. After the operator has installed the stirrer 60/60′, the operator starts the food cooker 100 through the operation interface 90. The controller 95 controls the fluid supply valve 80 to supply the fluid into the outer container 20. After the fluid level sensor 82 has sensed that the liquid level reaches the predetermined level or height, the fluid supply valve 80 is closed, and the heater 10 is turned on to heat the outer container 20 so that the liquid reaches the predetermined temperature (e.g., 100° C.). When the temperature sensor 83 detects that the liquid 1 has reached the predetermined temperature, the temperature sensor 83 informs the controller 95, and the controller 95 controls the driving mechanism 78 to move the quantity control barrel 74 to the location directly above the inlet window 42. Meanwhile, the outlet valve 75 and the feeding valve 43 are opened, and the food 2 is supplied to the inner container 30 and heated therein while the power source 50 is controlled to rotate the stirrer 60/60′ to stir the food. The heating energy of the heater 10 may be adjusted by the controller 95 according to the parameter database stored therein. After cooking is completed, the controller 95 turns off the heater 10, opens the fluid discharge valve 81 to discharge the liquid or fluid, and then controls the fluid supply valve 80 to open so that the cooling liquid, such as water, is provided to cool the food 2 upon stirring. Finally, the fluid discharge valve 81 is opened to discharge the liquid. Thus, the food cooking is completed. Then, the operator takes out the stirrer and the food, and cleans the inner container and the outer container.

After the actual tests using the same food are performed, the conventional artificial cooking method requires the cooking time of 85 minutes and the ratio of the tapioca balls to the water ranging from 1:6 to 1:8. This embodiment requires the cooking time less than 40 minutes and the ratio of the tapioca balls to the water ranging from 1:3 to 1:4. Thus, a lot of water can be saved, the cooking time can be shortened, and the operator's work load can be decreased.

With the above-mentioned embodiment of this disclosure, the provided food cooker has the detachable stirrer that can be rapidly detached and installed, and the automatic food supply device that can automatically feed the food. In addition, a lot of water can be saved, the cooking time can be shortened, the operator's load can be decreased, and the food with the uniform quality can be obtained.

While this disclosure has been described by way of examples and in terms of preferred embodiments, it is to be understood that this disclosure is not limited thereto. To the contrary, it is intended to cover various modifications. Therefore, the scope of the appended claims should be accorded the broadest interpretation so as to encompass all such modifications.

What is claimed is:

1. A food cooker, comprising:
a heater;
an outer container, which is removably placed on the heater and for accommodating a liquid, wherein the heater heats the outer container;
an inner container, which is removably placed within the outer container and has multiple through holes to allow the liquid to flow between the outer container and the inner container, wherein the inner container is for accommodating a food;
a cover disposed on the outer container;
a power source, which is disposed on the cover and has a driving shaft; and
a stirrer, which is detachably and rotatably disposed in the inner container, is detachably coupled to the driving shaft, and is rotated by the driving shaft to stir the food and the liquid.

2. The food cooker according to claim 1, further comprising:
a food supply device for supplying the food into the inner container, wherein a dispensing port of the food supply device is not located directly above the cover in a non-dispensing state, and is moved to a location directly above the cover in a dispensing state.

3. The food cooker according to claim 2, wherein the cover comprises: a base, which is formed with an inlet window and aligned with the dispensing port in the dispensing state; and a rotatable feeding valve connected to the base, wherein when the food supply device is moved from the non-dispensing state to the dispensing state, the food supply device pushes the feeding valve to rotate to expose the inlet window.

4. The food cooker according to claim 3, wherein when the food supply device is moved from the dispensing state to the non-dispensing state, the feeding valve falls down to close the inlet window by gravity.

5. The food cooker according to claim 4, wherein the feeding valve has a first plate and a second plate, which are connected together and are not co-planar with each other, an axial connection side of the first plate is rotatably connected to the base, and a free side of the second plate is pushed by the food supply device to open the feeding valve.

6. The food cooker according to claim 2, wherein the food supply device comprises:
a storage tank accommodating the food;
a quantity control member having a quantity control opening communicating with the storage tank;
a quantity control barrel, which has one end communicating with the quantity control opening, and the other end formed with the dispensing port, and is movable relatively to the storage tank; and
an outlet valve disposed at the dispensing port to close or open the dispensing port.

7. The food cooker according to claim 6, wherein the outlet valve is rotatably connected to the quantity control barrel, and the cover comprises: a base, which is formed with an inlet window and aligned with the dispensing port in the dispensing state; and a stopper structure disposed on the base, wherein when the quantity control barrel is moved to a location directly above the inlet window, a hook portion of the outlet valve is stopped by the stopper structure to rotate the outlet valve and open a food stopper of the outlet valve relatively to the dispensing port.

8. The food cooker according to claim 7, wherein the food supply device further comprises a driving mechanism driving the quantity control barrel to move.

9. The food cooker according to claim 2, further comprising:
a fluid supply valve communicating with the outer container and a fluid source, and controlling supplying of the liquid from the fluid source to the outer container or not; and
a fluid discharge valve communicating with the outer container and controlling discharging of the liquid from the outer container or not.

10. The food cooker according to claim 9, further comprising:
a fluid level sensor disposed on the cover and detecting a level of the liquid in the outer container or the inner container to generate a liquid level signal; and
a temperature sensor disposed on the cover and detecting a temperature of the liquid in the outer container or the inner container to generate a temperature signal.

11. The food cooker according to claim 10, further comprising:
an operation interface to be operated by an operator to generate an operation signal; and
a controller, which is electrically connected to the operation interface, the fluid supply valve, the fluid discharge valve, the fluid level sensor, the temperature sensor, the heater and the power source, and controls operations of the fluid supply valve, the fluid discharge valve, the heater and the power source according to the liquid level signal, the temperature signal and the operation signal.

12. The food cooker according to claim 1, wherein the inner container has a pillar, and the stirrer is rotatably connected to the pillar.

13. The food cooker according to claim 1, wherein the stirrer comprises:
a central shaft having a bottom end detachably and rotatably disposed in the inner container, and a top end detachably coupled to the driving shaft;
a horizontal lever, which is connected to the bottom end of the central shaft and stirs the food near a bottom of the inner container; and
multiple inclined levers, which are connected to the central shaft, extend slantingly from the central shaft, and stir the food, wherein one or two of the inclined levers are partially disposed in the liquid and partially disposed above the liquid.

14. The food cooker according to claim 13, wherein in two of the inclined levers abutting upon each other in a vertical direction, a free end of an upper one of the inclined levers is lower than or flush with a fixing end of the other lower one of the inclined levers.
